(19) United States
(12) Patent Application Publication
(10) Pub. No.: US 2025/0257563 A1
(43) Pub. Date: Aug. 14, 2025

(54) PLASTIC BRICK

(71) Applicant: Saad ALQAHTANI, Riyadh (SA)

(72) Inventor: Saad ALQAHTANI, Riyadh (SA)

(21) Appl. No.: 18/857,696

(22) PCT Filed: Apr. 18, 2023
(86) PCT No.: PCT/SA2023/050005

§ 371 Date: Oct. 17, 2024

(30) Foreign Application Priority Data
Apr. 18, 2022 (SA) 122430962

(51) Int. Cl. E04B 2/14; E04C 1/40

(52) U.S. Cl. CPC E04B 2/14; E04C 1/40; E04B 2103/04

(57) ABSTRACT

The present invention of the polymer bricks that are considered highly efficient in terms of mechanical properties, providing thermal insulation in buildings and reducing the operating energy of the building and the energy embodied in the manufacturing stages compared to concrete bricks (blocks) or ready-made concrete. The lattice-based plastic brick includes at least two solid plates and a plurality of lattice unit cells. The two solid plates include an inner layer and an outer layer. The lattice unit cells are sandwiched between the at least two solid plates in a predefined manner. The lattice unit cells is designed using topologies comprising triangle, diamond, hexagonal/honeycomb, cubic, polygonal, star, gyroid, and a combination thereof. The lattice unit cells includes struts of predefined thickness and length.

### FIELD OF INVENTION

The present invention relates to the field of civil engineering and more particularly the present invention relates to a plastic brick that is considered highly efficient in terms of mechanical properties, providing thermal insulation in buildings and reducing the operating energy of the building and the energy embodied in the manufacturing stages compared to concrete bricks (blocks) or ready-made concrete.

### BACKGROUND

The building sector is consuming approximately 40% of the total global end-use energy. Thermal insulation of the external building envelops plays a significant role in the energy consumption due to the heat transfer through it due to difference in external and indoor temperature. It is well-known fact that the better the thermal insulation of a building's exterior wall, the lower will be the cooling/heating loads and consequently reduction in the operating cost of the air-conditioning system. Therefore, several research studies were conducted on understanding and improving the thermal performance of the external building envelopes.

Another part of the literature is focused on thermal the performance of the building walls insulation with different structure materials under various thermal conditions. Although, with thicker insulation, bigger energy savings can be achieved but at a higher initial cost. The optimum insulation thickness is obviously the value that gives the minimum total cost, which includes the cost of insulation material and the cost of energy consumption over the lifetime of the building and insulation. Traditional insulation materials studied in the literature are mineral wool, Extended polystyrene (EPS), Cellulose, Cork and polyurethane. These traditional insulation materials are robust with respect to their flexibility and ease of use. However, they have relatively high thermal conductivity values which means a thick building envelope is required in order to reach the required thermal efficiency of a building. In addition, their thermal conductivity increases substantially with an increase in moisture contents i.e. they are vulnerable to moisture uptake.

There is an increasing demand to find alternative low-energy, sustainable materials not only to minimise the embodied and operational energy cost of the building but also to reduce the associated carbon footprint. The embodied energy cost arises due to the manufacturing of building products and processes used in initial construction, life cycle management and final demolition of a building, whereas the operational energy cost are associated with the air-conditioning, heating, lighting and operating building equipment. A substantial change in the design of a building materials is required to significantly reduce both embodied and operational energy costs of the building. This invention focuses on such design to develop thermally efficient alternative building blocks for the built environment.

For a long time, the lattice structure materials were targeted for structural applications. As a result, various studies focused on design, manufacturing and the effective mechanical properties of lattice structures. A limited number of studies aimed at the thermal performance of AM metallic and ceramic lattice materials are found in the literature. The prime objective of these invention was to use the lattices and porous as efficient compact heat exchangers to enhance the thermal conductivity of heat exchangers and other heat removal applications such as aircraft electric motors etc. However, the utilise of polymer-based lattice structure with enclosed air cavities manufactured via additive manufacturing is yet to be used as a building envelope.

Moreover, the polymer concrete PCs and their construction are of primary interest to researchers. For example, the PC's strength properties while using epoxy resin can improve the workability and the compressive strength. Additionally, a recent study was conducted to characterize the physical properties of the concrete hollow block using pelletized aggregates of polystyrene. It shows that compressive strength values were statically at per with the commercially produced concrete hollow block. Nevertheless, the necessity of developing lightweight but with high thermal performance materials such as polymer was the reason behind this innovation. Thus, the high porosity of the lattice topology and high thermal performance of the periodic lattice structure, the AM polymer lattice incorporates lightweight characteristics, high service thermal insulation and load bearing is very promising for an energy-efficient construction building.

### CROSS REFERENCES

Saudi Industrial Model No. 421420714 dated 30 May 2021G—This closest prior is showing only the appearance of the article and not structural or utilitarian/technical features. The present invention is providing which is highly efficient in terms of mechanical properties, providing thermal insulation in buildings and reducing the operating energy of the building and the energy embodied in the manufacturing stages compared to concrete bricks (blocks) or ready-made concrete and that is lightweight. The present invention is disclosing a lattice-based plastic brick or rectangular block which comprise: two solid plates having an inner layer and an outer layer; and lattice unit cells, and which is being sandwiched between the two solid plates in a predefined unique manner.

CN107805077A discloses a composite low-aluminium lattice brick and the production method thereof. The composite low-aluminium lattice brick comprises a clay brick base body with multiple airflow passages, and the inner walls of the airflow passages are provided with highly-siliceous coating layers by compounding. The brick base body is made by adding a small quantity of plastic clay and a binding agent into the main materials including flint clay, siliceous chamotte, pyrophyllite raw materials, molten quartz and siliceous clay raw materials.

JP2004197476A discloses a brick-like building element. The brick-like building element includes a plastic body, the lower surface of which is open, and which is hollow and moulded to have an outline similar to a brick.

U.S. design patent USD608025S to 3FORM INC shows ornamental views of architectural panel with lattice.

Prior art document failed to disclose a plastic brick that uses recycled plastic, which is highly efficient in terms of mechanical properties, providing thermal insulation in buildings and reducing the operating energy of the building and the energy embodied in the manufacturing stages compared to concrete bricks (blocks) or ready-made concrete and that is lightweight.

Therefore, there is a need for a plastic brick that overcomes the problems prevalent in the prior art document.

### SUMMARY

The present invention is disclosing a lattice-based plastic brick or rectangular block which comprise: two solid plates having an inner layer and an outer layer; and lattice unit cells, and which is being sandwiched between the two solid plates in a predefined unique manner.

The present invention provides a Polymer Brick that solves the problems prevalent in the prior art.

An object of the present invention is to provide a plastic brick that uses recycled plastic.

Another object of the present invention is to provide a plastic brick that is considered highly efficient in terms of mechanical properties, providing thermal insulation in buildings.

Another object of the present invention is to provide a plastic brick that reduces the operating energy of the building and the energy embodied in the manufacturing stages compared to concrete bricks (blocks) or ready-made concrete.

Another object of the present invention is to provide a plastic brick that is lightweight compared to concrete and cement bricks and ready-made cement blocks.

According to an embodiment of the present invention, the lattice-based plastic brick includes at least two solid plates and a plurality of lattice unit cells. The two solid plates include an inner layer and an outer layer. The lattice unit cells are sandwiched between at least two solid plates in a predefined manner. The relative density of the plurality of polymer lattice unit cells ranges from 5% to 80%. The lattice unit cells are designed using topologies comprising triangle, diamond, hexagonal/honeycomb, cubic, polygonal, star, gyroid, and a combination thereof. The lattice unit cells include struts of predefined thickness and length.

According to an embodiment of the present invention, the lattice unit cells are manufactured using the 3D printing technique, using moulds by moulding process and injecting polymer materials, or robot machines. The lattice unit cells are manufactured within different densities, topologies, and thicknesses manufactured vertically or horizontally, depending on the applications. The lattice unit cells are manufactured horizontally and perpendicularly to heat flow. The lattice unit cells are manufactured using polymeric and/or composite polymer materials. The lattice unit cells are manufactured along with sand, cement, powder, and fibres. The solid plates are manufactured using polymeric and/or composite polymer materials. The solid plates (are manufactured along with sand, cement, powder, and fibres. The brick forms a panel.

According to an embodiment of the present invention, the bricks are utilized to build the walls of construction buildings in general and in some other applications such as (mobile vehicles, garages, warehouses, immunization rooms, . . . etc.).

An object of the present invention is to provide a plastic brick that uses recycled plastic.

Another object of the present invention is to provide a plastic brick that is considered highly efficient in terms of mechanical properties, providing thermal insulation in buildings and reducing the operating energy of the building and the energy embodied in the manufacturing stages compared to concrete bricks (blocks) or ready-made concrete.

Another object of the present invention is to provide a plastic brick that is lightweight compared to concrete and cement bricks and ready-made cement blocks.

According to an embodiment of the present invention, the lattice-based plastic brick includes at least two solid plates and a plurality of lattice unit cells. The two solid plates include an inner layer and an outer layer. The lattice unit cells are sandwiched between at least two solid plates in a predefined manner. The relative density of the plurality of polymer lattice unit cells ranges from 5% to 80%. The lattice unit cells are designed using topologies comprising triangle, diamond, hexagonal/honeycomb, cubic, polygonal, star, gyroid, and a combination thereof. The lattice unit cells include struts of predefined thickness and length.

According to an embodiment of the present invention, the lattice unit cells are manufactured using the 3D printing technique, using moulds by moulding process and injecting polymer materials, or robot machines. The lattice unit cells are manufactured within different densities, topologies, and thicknesses manufactured vertically or horizontally, depending on the applications. The lattice unit cells are manufactured horizontally and perpendicularly to heat flow. The lattice unit cells are manufactured using polymeric and/or composite polymer materials. The lattice unit cells are manufactured along with sand, cement, powder, and fibres. The solid plates are manufactured using polymeric and/or composite polymer materials. The solid plates are manufactured along with sand, cement, powder, and fibres. The brick forms a panel.

### BRIEF DESCRIPTION OF THE DRAWINGS

FIG. 1 (a) shows a geometrical structure of the lattice-based brick according to an embodiment of the present invention;

FIG. 1 (b) (c) and (d) shows optical microscopy images for triangular, diamond, honeycomb like lattice unit cells respectively;

FIG. 2 shows an orientations of the lattice unit cells manufactured horizontally and perpendicularly to the heat flow;

FIG. 3 shows a polymer brick manufactured using triangle lattice unit cells in accordance with the present invention; and

FIG. 4 shows a lattice panel of cross section area 1 m² manufactured using casting mould with critical unit cells size (hydraulic diameter) according to another embodiment of the present invention.

### DETAILED DESCRIPTION OF THE INVENTION

The present invention provides plastic brick (100) using lattice structures can tackle building challenges for sustainability.

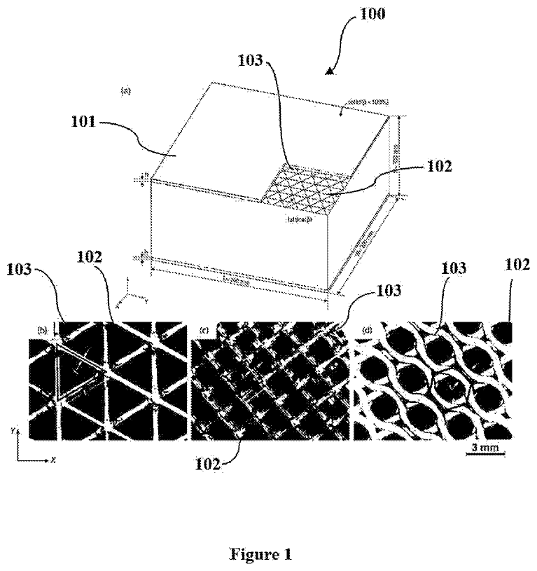

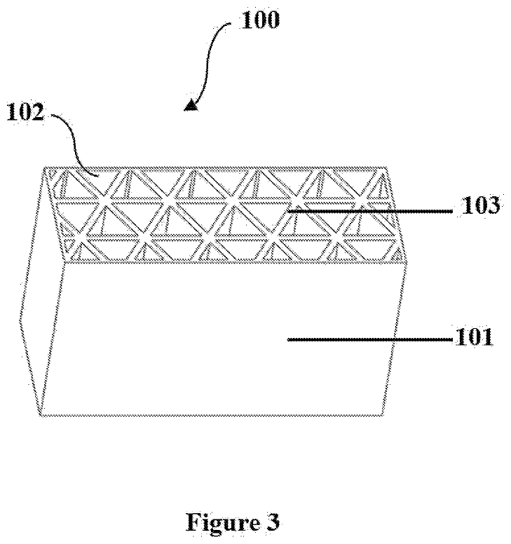

Referring now to FIGS. 1 (a), 3 and 4, the lattice-based plastic brick (100) includes at least two solid plates (101) and a plurality of lattice unit cells (102). The two solid plates (101) include an inner layer and an outer layer. The lattice unit cells (102) are sandwiched between the solid plates (101) in a predefined manner. The relative density of the plurality of polymer lattice unit cells (102) ranges from 5% to 80%. The lattice unit cells (101) are designed using topologies comprising triangle, diamond, hexagonal/honeycomb, cubic, polygonal, star, gyroid, and a combination thereof as best seen in FIGS. 1(b), 1(c) and 1(d). The lattice unit cells (102) include struts (103) of predefined thickness and length. The struts (103) are connected together to form a lattice unit cell (102). The strut (103) provides strength to the brick (100).

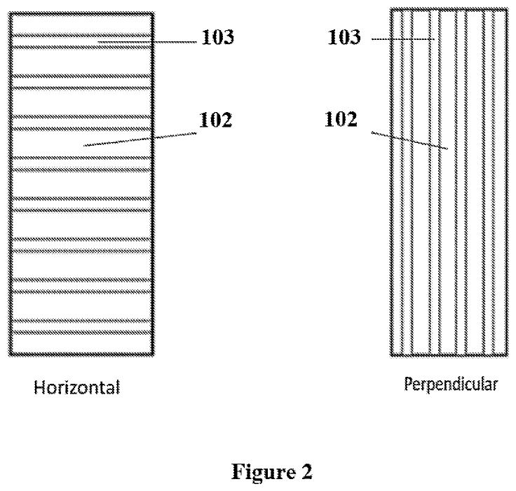

The lattice unit cells (102) are manufactured using the 3D printing technique, using moulds by moulding process and injecting polymer materials, or robot machines. The lattice unit cells (102) are manufactured within different densities, topologies, and thicknesses manufactured vertically or horizontally, depending on the applications. The lattice unit cells (102) are manufactured horizontally and perpendicularly to heat flow (refer FIG. 2).

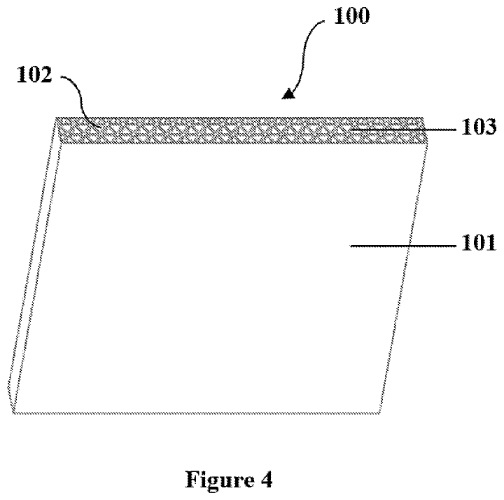

The lattice unit cells (102) are manufactured using polymeric and/or composite polymer materials. In an alternative embodiment of the present invention, the lattice unit cells (102) are manufactured along with sand, cement, powder, and fibres. The solid plates (101) are manufactured using polymeric and/or composite polymer materials. In one more embodiment, the solid plates (101) are manufactured along with sand, cement, powder, and fibres. Referring now to FIG. 4, the brick (100) forms a panel.

Since additive manufacturing requires the part or structure to be generated as a 3D model in a suitable 3D CAD modelling software, a 3D printer is used to generate the lattice unit cell (102) with different relative densities. In all lattices, the unit cell's (102) relative density ρ̅ is characterised by the thickness of struts (t) and their length (l).

The bricks (100) are utilized to build the walls of construction buildings in general and in some other applications such as (mobile vehicles, garages, warehouses, immunization rooms, . . . etc.). The use of polymer brick (100) is environmentally friendly during the manufacturing stages, which reduces carbon dioxide emissions from factories during the production of building materials and the possibility and ease of recycling. In addition, the construction technology using the polymer bricks (100) helps to reduce the total building cost, including embodied energy and rapid production of the building unit in the factory and installation on the site. The polymer bricks (100) also contribute to economic growth by providing job opportunities in the factory in a safe environment and reducing risks on construction sites.

Due to the high porosity of the lattice unit cell (102) and high thermal performance of the periodic lattice structure, the polymer lattice panel incorporates lightweight characteristics, high service thermal insulation, and load bearing. Therefore, the polymer brick (100) is an energy-efficient construction building material.

1. A lattice-based plastic brick comprising:
at least two solid plates comprising an inner layer and an outer layer;
a plurality of lattice unit cells sandwiched between the at least two solid plates in a predefined manner.

2. The brick as claimed in claim 1, wherein the relative density of the plurality of lattice unit cells ranges from 5% to 80%.

3. The brick as claimed in claim 1, wherein the plurality of lattice unit cells is manufactured horizontally or perpendicularly to heat flow.

4. The brick as claimed in claim 1, wherein the each of the at least two solid plates are manufactured using polymeric and/or composite polymer materials.

5. The brick as claimed in claim 8, wherein the plurality of lattice unit cells is manufactured along with sand, cement, powder, fibres.

6. The brick as claimed in claim 9, wherein the each of the at least two solid plates are manufactured along with sand, cement, powder, fibres.

7. The brick as claimed in claim 1, wherein the plurality of lattice unit cells is designed using topologies comprising triangle, hexagonal/honeycomb, gyroid, or a combination thereof.
